(19) United States
(12) Patent Application Publication
(10) Pub. No.: US 2019/0341201 A1
(43) Pub. Date: Nov. 7, 2019

(54) ELECTRODE FOR AN ELECTROCHEMICAL BUNDLE OF A METAL-ION STORAGE BATTERY OR A SUPERCAPACITOR, METHOD FOR PRODUCING THE ASSOCIATED BUNDLE AND STORAGE BATTERY

(71) Applicant: COMMISSARIAT A L'ENERGIE ATOMIQUE ET AUX ENERGIES ALTERNATIVES, Paris (FR)

(72) Inventors: Marianne CHAMI, Fontaine (FR); Frédéric DEWULF, Voiron (FR)

(21) Appl. No.: 16/310,028

(22) PCT Filed: Jun. 8, 2017
(86) PCT No.: PCT/EP2017/063910

§ 371 Date: Dec. 14, 2018

(30) Foreign Application Priority Data
Jun. 15, 2016 (FR) 1655541

(51) Int. Cl. H01G 11/26; H01M 10/0587; H01M 10/04; H01M 2/26

(52) U.S. Cl. CPC H01G 11/26; H01M 10/0587; H01M 2/263; H01M 2/266; H01M 10/0413

(57) ABSTRACT

The present invention relates to an electrode (2, 3) for an electrochemical bundle of a metal-ion storage battery or of a supercapacitor, comprising a substrate (2S, 3S) formed from a metal strip that supports an active metal-ion insertion material (2I, 3I) in its central portion (22, 32), while its lateral band, referred to as the edge (20, 30), is devoid of active insertion material, the lateral band comprising an end area (21, 31), in which the properties of the metal material and/or geometry of which is/are modified in relation to the rest of the strip in the edge (20, 30) and in the central portion (22, 32), so as to cause localized plastic buckling in the end area when a predetermined compressive force (E) is applied to the end area, the central portion not deforming under the predetermined compressive force.

### TECHNICAL FIELD

The present invention relates to the field of metal-ion electrochemical generators, which function according to the principle of insertion or deinsertion, or in other words intercalation-deintercalation, of metal ions in at least one electrode.

It relates more particularly to a metal-ion electrochemical storage battery comprising at least one electrochemical cell consisting of an anode and a cathode on either side of an electrolyte-impregnated separator, two current collectors, one of which is connected to the anode and the other to the cathode, and a case of a shape that is elongated along a longitudinal axis (X), the case being arranged to house the electrochemical cell hermetically while being traversed by a portion of the current collectors forming the output terminals, also called poles.

The separator may consist of one or more films.

The case may comprise a cover and a container, or may comprise a cover, a base and a lateral envelope joined both to the bottom and to the cover.

The present invention aims to improve the design of a part of the electrical connection between at least one electrochemical cell of the storage battery and its output terminals integrated with its case.

It aims more particularly to improve the method of compacting the lateral bands of electrodes lacking active insertion material, onto which, once compacted, a current collector in the form of a plate is welded.

Although described with reference to a lithium-ion storage battery, the invention applies to any metal-ion electrochemical storage battery, i.e. also sodium-ion, magnesium-ion, aluminum-ion, etc.

The invention also applies to the production of an electrochemical bundle of a supercapacitor and the connection to its case.

### PRIOR ART

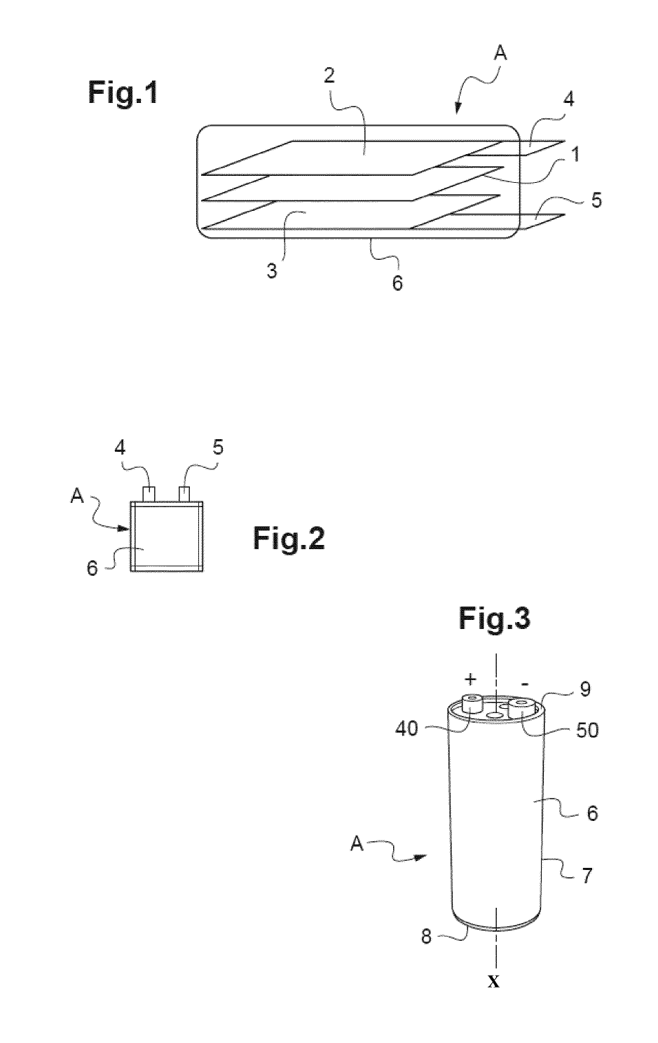

As illustrated schematically in FIGS. 1 and 2, a lithium-ion storage battery or accumulator usually comprises at least one electrochemical cell C consisting of a separator impregnated with an electrolyte constituent 1 between a positive electrode or cathode 2 and a negative electrode or anode 3, a current collector 4 connected to the cathode 2, a current collector 5 connected to the anode 3 and finally a container 6 configured for containing the electrochemical cell hermetically while being traversed by a portion of the current collectors 4, 5, forming the output terminals.

The architecture of the conventional lithium-ion batteries is an architecture that may be described as monopolar, as there is a single electrochemical cell comprising an anode, a cathode and an electrolyte. Several types of geometry of monopolar architecture are known:
a cylindrical geometry as disclosed in patent application US 2006/0121348,
a prismatic geometry as disclosed in U.S. Pat. Nos. 7,348,098, 7,338,733;
a stack geometry as disclosed in patent applications US 2008/060189, US 2008/0057392, and patent U.S. Pat. No. 7,335,448.

The electrolyte constituent may be in the form of solid, liquid or gel. In this last-mentioned form, the constituent may comprise a separator made of polymer or of microporous composite impregnated with organic electrolyte(s) or of the ionic liquid type which allows movement of the lithium ion from the cathode to the anode for charging and vice versa for discharging, which generates the current. The electrolyte is generally a mixture of organic solvents, for example of carbonates in which a lithium salt, typically LiPF6, is added.

The positive electrode or cathode consists of lithium cation insertion materials, which are generally composite, such as lithiated iron phosphate LiFePO₄, lithiated cobalt oxide LiCoO₂, lithiated manganese oxide, optionally substituted, LiMn₂O₄ or a material based on LiNiₓMn_{y}Co_{z}O₂ with x+y+z=1, such as LiNi_{0.33}Mn_{0.33}CO_{0.33}O₂, or a material based on LiNiₓCo_{y}Al_{z}O₂ with x+y+z=1, LiMn₂O₄, LiNiMnCoO₂ or lithiated nickel cobalt aluminum oxide LiNiCoAlO₂.

The negative electrode or anode very often consists of carbon, graphite or is made of Li₄TiO₅O₁₂ (titanate material), optionally also based on silicon or based on lithium, or based on tin and alloys thereof or of a composite formed on the basis of silicon. This negative electrode, like the positive electrode, may also contain electron conducting additives as well as polymer additives which endow it with mechanical properties and electrochemical performance suitable for the lithium-ion battery application or for its method of implementation.

The anode and the cathode made of lithium insertion material may be deposited continuously by a usual technique in the form of an active layer on a metal sheet or strip constituting a current collector.

The current collector connected to the positive electrode is generally made of aluminum.

The current collector connected to the negative electrode is generally made of copper, nickel-plated copper or aluminum.

Conventionally, a lithium-ion storage battery or accumulator uses a pair of materials at the anode and at the cathode that allow it to operate at a high voltage level, typically between 3 and 4.1 V.

A lithium-ion storage battery or accumulator comprises a rigid container or case when the intended applications are restrictive, where a long service life is required, with for example much higher pressures to be withstood and a more stringent required level of hermeticity, typically below 10⁻⁶ mbar·l/s of helium, or in environments with high stresses such as the aeronautical or space sector. The main advantage of rigid containers is thus their high hermeticity that is maintained over time because the cases are closed by welding, generally by laser welding.

The geometry of most of the rigid cases for containers of Li-ion storage batteries is cylindrical, as most of the electrochemical cells of storage batteries are wound by winding according to a cylindrical geometry. Prismatic shapes of cases have also already been produced.

One type of rigid case of cylindrical shape, usually made for a high-capacity Li-ion storage battery with a service life longer than 10 years, is illustrated in FIG. 3.

The case 6 with a longitudinal axis X comprises a cylindrical lateral envelope 7, a base 8 at one end, and a cover 9 at the other end. The cover 9 supports the poles or output terminals 40, 50 for the current. One of the output terminals (poles), for example the positive terminal 40, is welded on the cover 9 whereas the other output terminal, for example the negative terminal 50, passes through the cover 9 with interposition of a seal (not shown) which insulates the negative terminal 50 electrically from the cover.

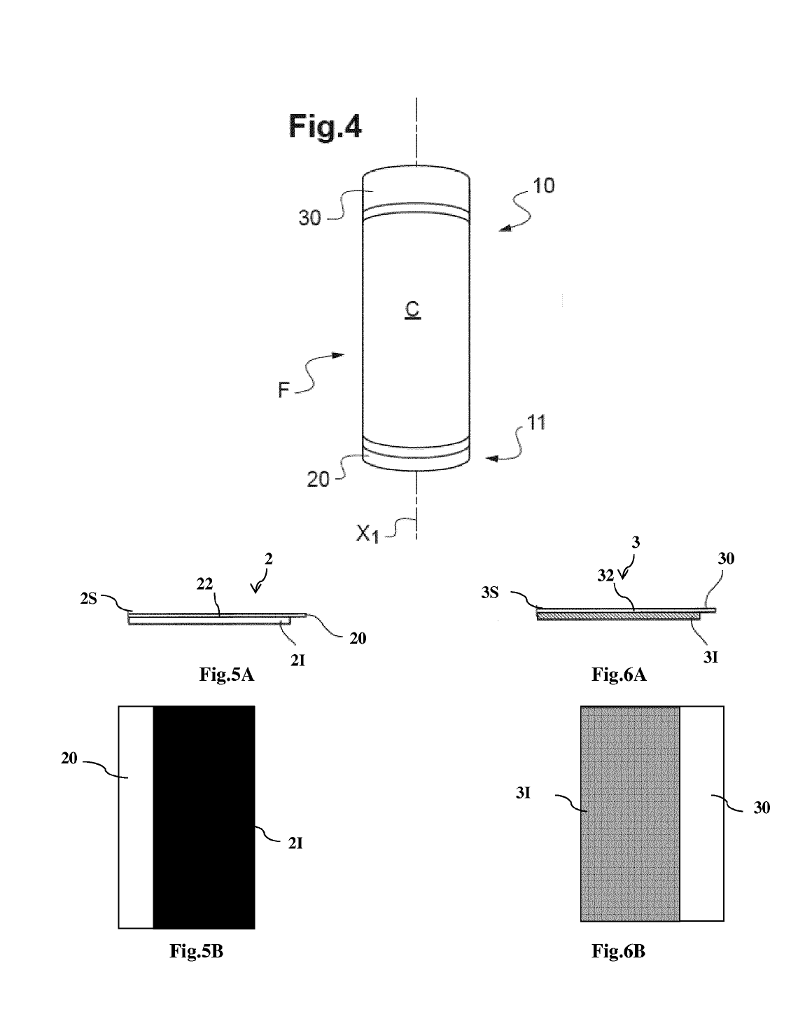

FIG. 4 shows photographs of an electrochemical bundle F of elongated shape along a longitudinal axis X1 and comprising a single electrochemical cell C, usually wound by winding before the steps of placing in a case, with electrical connection to the output terminals of the storage battery and its impregnation with an electrolyte. The cell C consists of an anode 3 and a cathode 4 on either side of a separator (not visible) suitable for being impregnated with the electrolyte. As can be seen, one 10 of its lateral ends of the bundle F is delimited by the band 30 of the uncoated anode 3, whereas the other 11 of its lateral ends is delimited by the band 20 of the uncoated cathode 2.

Here, and in the context of the invention, “uncoated band” or “edge” means a lateral portion of a metal sheet, also called strips, forming a current collector, which is not covered with an insertion material for metal ions, such as lithium in the case of a lithium-ion battery.

FIGS. 5A and 5B and FIGS. 6A and 6B, respectively, show in more detail a positive electrode or cathode 2 and a negative electrode or anode 3, starting from which an existing electrochemical bundle is produced by winding with a separator 4 inserted between cathode 2 and anode 3. The cathode 2 consists of a substrate 2S formed of a metal strip that supports, in its central portion, 22, an active lithium insertion material 2I, whereas its lateral band (edge) 20 lacks active insertion material. Moreover, the anode 3 consists of a substrate 2S formed of a metal strip that supports, in its central portion, 32, an active lithium insertion material 3I, and its edge 30 lacks active insertion material. Each metal strip 2S, 3S is as a single piece, i.e. geometric and metallurgical characteristics on its whole surface.

The aim of manufacturers of batteries is to increase the autonomy of a cell making up the battery or their ability to function under high power regimes while improving their service life, i.e. their possible number of cycles, their lightness and the costs of production of these components.

The routes for improving Li-ion batteries mainly relate to the nature of the materials and the methods of production of the electrochemical cell components.

Other possible routes for improvements, less numerous, relate to the battery cases and the methods and means for electrical connection of an electrochemical bundle to the two output terminals, also called poles of different polarity of the battery.

Up to now, when we want to make an electrical connection between the electrochemical bundle and the output terminals of a lithium-ion battery of cylindrical or prismatic geometry, which is of high quality, the following design rules are observed as far as possible:
satisfy the needs of an application in electrical conduction between each polarity of electrodes and the output terminals integrated with the battery case, for example in order to respond to power peaks while limiting heating inside the battery, which is likely to accelerate its electrochemical aging;
minimize the overall level of internal resistance of the battery by making the electrical connection directly on the current collectors of the electrodes for each polarity and by connecting an intermediate connector between the electrochemical bundle and the battery case;
simplify the connection to the electrochemical bundle, by making the connection directly on the lateral bands not covered with electrodes, also called edges, delimiting the two opposite lateral ends of the bundle respectively;
optimize the characteristics (thickness, height, weight) and profiles of the lateral bands not covered with electrodes for making said electrical connection, in order to satisfy the final assembly steps in the best possible way, i.e. the steps of integrating the electrochemical bundle in the case, closing the battery case, filling with electrolyte, etc.
minimize the weight and volume necessary for making the electrical connection, which as such is not a generator of electrochemical energy, but which are necessary for transfer of energy by the electrochemical bundle to outside the battery case.

In the literature describing solutions for producing an electrochemical bundle of a battery of cylindrical or prismatic shape and electrical connection thereof to the output terminals integrated with its case, we may mention the following documents.

Patent FR 2094491 discloses an alkaline battery in which the electrical connection between the wound electrochemical cell and output terminals is obtained by cutting into the edges of the electrodes with regularly spaced slits, and then radial crimping of these slit edges from the exterior to the interior in the form of superposed scales in order to form a substantially flat base on which a current collector is finally welded, consisting if applicable of the cover of the case.

Patent application EP 1102337 discloses a lithium-ion battery in which the electrical connection between the wound electrochemical cell and output terminals is obtained by a single pressing of each end of the electrode strips of the wound cell, along the winding axis, by means of a pressing mandrel and then by laser welding of each end of the electrode strips to a terminal current collector consisting of foil in the form of a disk and a connecting tab itself laser-welded afterwards to the cover of the case at one end, and to the base of the case at the other end. Ribs are made, each on a diameter of the disk, and they themselves are pressed prior to welding against the ends of pressed electrode strips.

Patent application EP 1596449 describes a lithium-ion battery in which the electrical connection between the wound electrochemical cell and output terminals is obtained firstly by multiple pressing of each lateral end delimited by the bands not covered with electrodes of the wound cell, by means of a pressing mandrel with an outside diameter between 15 and 20 mm. The pressing mandrel moves over a very short course alternately from the exterior to the interior of the cell parallel to the winding axis, sweeping the entire lateral surface of the bands not covered with electrodes to produce entanglement between the latter by forming a dense, flat base on which a terminal current collector is welded by laser or by transparency consisting of a foil in the form of a flat connecting band in its turn welded by laser or by transparency afterwards to an output terminal integrated with the cover at one lateral end and to the base of the case at the other lateral end.

Patent EP1223592B1, which relates more to the field of supercapacitors, describes a technique for electrical connection of current collectors to the electrochemical bundle by directly supporting the collectors in the form of a plate on the edges.

U.S. Pat. No. 6,631,074B2, which also relates to supercapacitors, describes a solution that consists of spraying an electrically conductive substance, such as aluminum, on the surfaces at each end of the electrochemical bundle, so as to obtain, for each end, continuity of electrical contact surface between all the strips at the level of the electrode edges, each surface then being welded by laser welding to the current collector.

On analyzing all the known solutions for producing an electrochemical bundle of a lithium battery and of electrical connection thereof to the output terminals of the battery, as described above, the inventors came to the conclusion that the latter could be further perfected in many aspects.

Firstly, the weight and volume of the lateral bands not covered with electrodes (edges) necessary for electrical connection to the current collectors according to the prior art are not necessarily optimized, which ultimately means that the weight and volume of the battery have also not yet been optimized.

Next, the inventors found that in fact the edges of one and the same lateral end were not necessarily connected together electrically, in particular the portions of these edges located in the most peripheral zone of the bundle. This means a reduced real specific capacity of the electrochemical bundle, which may be detrimental in particular for the high power applications for the battery.

Furthermore, the step of filling the electrolyte in an electrochemical bundle of a lithium battery may prove relatively long and difficult because the current collectors according to the prior art, being welded on the edges of the electrochemical bundle of a battery, constitute an appreciable obstacle to passage of the electrolyte.

Finally, regarding the techniques with axial compacting of the electrode strips at the level of their edges, several specific drawbacks may arise.

Thus, the mechanical stress of compression to be applied during compacting to obtain a layer of dense folded edges must be high. Now, at present, all the metal strips of the electrodes of one and the same polarity have the same mechanical durability over the entire width of the bundle. This may lead to a difference in folding between the strips, in particular with greater folding at the level of the core of the bundle, which may even result in short-circuits.

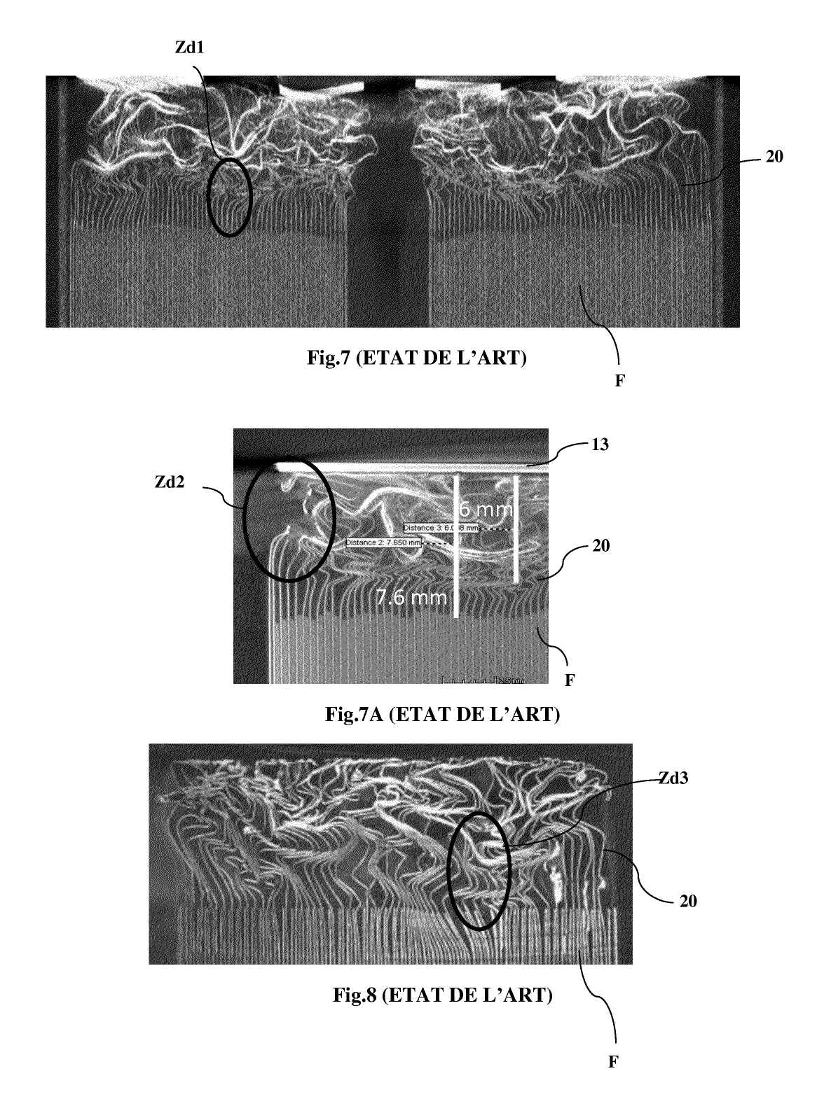

Such a configuration is shown in FIG. 7: the circled zone Zd1 shows the more substantial folding of the electrode edge 20 at the core of the electrochemical bundle F.

Moreover, when the layer of compacted edge is insufficient, the operation of welding a metallic part forming a current collector or of different wound portions of one and the same strip may produce strong heating, which may be propagated as far as the separator, which then melts, which also causes short-circuits.

FIG. 7A, which is a detail view from FIG. 7, shows a configuration in which the layer of edges 20, which is insufficiently dense at the periphery, caused undesirable localized melting during welding of the current collector 13: the circled zone Zd2 is a zone of lower density, in which there has been local melting of the edge 20.

FIG. 8 illustrates a zone Zd3 of melting together of the portions of the electrode edge 20.

There is therefore a need to improve the production of an electrochemical bundle of a lithium battery, and more generally of a metal-ion battery or of a supercapacitor and of electrical connection thereof to the output terminals, notably with a view to better control of the axial compacting of the electrode edges while uniformly densifying it over the full width of the electrochemical bundle.

The aim of the invention is to meet this need at least partly.

### SUMMARY OF THE INVENTION

For this purpose, in one of its aspects the invention relates to an electrode for an electrochemical bundle of a metal-ion battery or of a supercapacitor, comprising a substrate formed of a metal strip that supports, in its central portion, an active metal-ion insertion material, whereas its lateral band, the so-called edge, lacks active insertion material, the lateral band comprising an end zone where the properties of its metallic material and/or its geometry is (are) modified relative to the rest of the strip in the edge and in the central portion, so as to cause localized plastic buckling on the end zone when a predetermined compressive stress (E) is applied on said end zone, the central portion not deforming under the predetermined compressive stress.

“Plastic buckling” is to be understood in its usual sense, i.e. buckling caused by compressive stress, leading to irreversible mechanical deformation.

According to an advantageous embodiment, the lateral band comprises an intermediate zone, between the central portion and the end zone, in which the properties of its metallic material and/or its geometry are selected in such a way that said intermediate zone does not deform under the predetermined compressive stress. This intermediate zone makes production safer, by mechanically protecting the core of the electrochemical bundle comprising the active insertion materials, during the steps of compacting and welding of the current collector to the compacted end zone.

To modify the material properties in the zones to be deformed so as to obtain a gradient of mechanical properties over the height of the electrochemical bundle, according to another variant embodiment, the Young's modulus and/or the elastic limit of the end zone is (are) modified by applying one or more thermomechanical treatments. The strip may also have a gradient of metallurgical state between the end zone and the intermediate zone.

Thus, it is possible to modify the microstructure (grain size, work-hardening, appearance of precipitates) of the end zone by various thermomechanical treatments (control of quenching rates, choice of tempering temperature), which generates a gradient of microstructure between the intermediate zone and the end zone.

It is preferable to use usual heat treatments (quenching, tempering, annealing), which lead to a change in mechanical properties in the existing crystalline structure, rather than chemical treatments, which could cause contamination. Reference may be made to publication [1] for these usual treatments.

The geometry of the end zone may be modified independently.

Thus, according to another variant, the thickness of the strip in the end zone may be less than that of the rest of the strip in the edge and in the central portion.

For localized thickness reduction, localized rolling of the metal strip may be carried out prior to coating thereof in its central portion with the active insertion material.

According to yet another variant embodiment, the intermediate zone may comprise stiffeners distributed uniformly along its length, i.e. over the height of the electrochemical bundle.

To weaken the strip mechanically, it may advantageously be pierced with holes or slits or cavities uniformly distributed in the end zone.

The strip may also advantageously be provided with at least one continuous groove along the length of the end zone. Thus, the modified geometry of the end zone with structural defects (cavities, continuous groove) or thickness reductions (holes, slits) will promote the development of instability of deformation of said zone during axial compacting of the bundle at this end.

The width of the end zone, once the compressive stress is applied, is preferably between 0.5 and 4 mm.

Preferably, the strip may have a thickness between 5 and 20 μm in the end zone and a thickness between 10 and 20 μm in the central portion.

The electrode strip may be of aluminum or of copper.

In another aspect, and according to a first alternative, the invention also relates to a method for producing an electrochemical bundle (F) of a metal-ion battery (A) such as a lithium-ion battery, or of a supercapacitor, with a view to electrical connection thereof to the output terminals of the battery, comprising the following steps:

a/ supplying an electrochemical bundle (F) comprising at least one electrochemical cell (C) consisting of a cathode as described above and an anode as described above, on either side of a separator suitable for being impregnated with an electrolyte, the bundle having an elongated shape along a longitudinal axis X1, with the lateral band of the anode at one lateral end, and the lateral band of the cathode at the other lateral end;

b/ axial compacting along axis X1 of at least one of the lateral bands of the electrochemical bundle; axial compacting being carried out once or twice so as to obtain, on at least one lateral end of the bundle, a compacted end zone forming a substantially flat, continuous base, intended to be welded to a current collector.

According to a second alternative, the following steps may be carried out:

a′/ supplying an electrochemical bundle (F) comprising at least one electrochemical cell (C) consisting of a cathode and an anode on either side of a separator suitable for being impregnated with an electrolyte, the cathode and the anode each comprising a substrate, formed of a metal strip that supports, in its central portion, an active metal-ion insertion material, whereas its lateral band, called edge, lacks active insertion material and the properties of its metallic material and its geometry are identical to the rest of the strip in the edge and in the central portion, the bundle having an elongated shape along a longitudinal axis X1, with the lateral band of the anode at one lateral end and the lateral band or bands of the cathode at the other lateral end;

b′/ axial compacting along axis X1 of at least one of the lateral bands of the electrochemical bundle with, beforehand or simultaneously, modification of the temperature of an end zone of said lateral band, the axial compacting being carried out once or twice so as to obtain, on at least one lateral end of the bundle, a compacted end zone forming a substantially flat, continuous base, intended to be welded to a current collector.

According to a third alternative, the following steps may be carried out:

a″/ supplying an electrochemical bundle (F) comprising at least one electrochemical cell (C) consisting of a cathode and an anode on either side of a separator suitable for being impregnated with an electrolyte, the cathode and the anode each comprising a substrate, formed of a metal strip that supports, in its central portion, an active metal-ion insertion material, whereas its lateral band, called edge, lacks active insertion material and the properties of its metallic material and its geometry are identical to the rest of the strip in the edge and in the central portion, the bundle having an elongated shape along a longitudinal axis X1, with the lateral band of the anode at one lateral end and the lateral band or bands of the cathode at the other lateral end;

b″/ axial compacting along axis X1 of at least one of the lateral bands of the electrochemical bundle with, simultaneously, clamping radially to axis X1, of an intermediate zone of said lateral band, leaving one end zone free radially, the axial compacting being carried out once or twice so as to obtain, on at least one lateral end of the bundle, a compacted end zone forming a substantially flat, continuous base, intended to be welded to a current collector.

Thus, according to the second and third alternatives, the end zone modified relative to the rest of the electrode is so during the compacting process.

In other words, here it is possible to start from ordinary electrodes and modify the conditions (localized heating of the end of the bundle, localized stiffening of the intermediate zone of the electrodes by radial clamping) of the process to modify the mechanical behavior of the end zone during the compression due to the axial compacting.

The height of the compacted end zone on a lateral end is preferably less than 4 mm, preferably between 0.5 and 2.5 mm.

According to an advantageous embodiment, the electrochemical bundle consists of a single electrochemical cell wound on itself by winding.

According to this embodiment, the gap between the anode strip and the cathode strip, considered in their central portion after winding, is preferably between 100 and 500 μm.

In another of its aspects, the invention also relates to a method for producing an electrical connection portion between an electrochemical bundle (F) of a metal-ion battery (A) and one of the output terminals of the battery, comprising the following steps:
producing an electrochemical bundle (F) by one of the methods just described;
welding the base obtained to a current collector intended in its turn to be joined or connected electrically to an output terminal of the battery.

The invention finally relates to a metal-ion battery or accumulator, such as a lithium (Li-ion) battery or a supercapacitor comprising a case comprising:
a base that is welded to one of the current collectors welded to the electrochemical bundle by the method described above; and
a cover with a lead-in forming an output terminal to which the other one of the current collectors is welded, welded to the electrochemical bundle by the method described above.

Preferably, for a lithium-ion battery or accumulator:
the case is based on aluminum;
the negative electrode metal strip is made of copper;
the active insertion material of negative electrode(s) is selected from the group comprising graphite, lithium, titanate oxide Li₄TiO₅O₁₂; or based on silicon or based on lithium, or based on tin and alloys thereof;
the metal strip of positive electrode(s) is of aluminum;
the active insertion material of positive electrode(s) is selected from the group comprising lithiated iron phosphate LiFePO₄, lithiated cobalt oxide LiCoO₂, lithiated manganese oxide, optionally substituted, LiMn₂O₄ or a material based on LiNiₓMn_{y}Co_{z}O₂ with x+y+z=1, such as LiNi_{0.33}Mn_{0.33}CO_{0.33}O₂, or a material based on LiNiₓCo_{y}Al_{z}O₂ with x+y+z=1, LiMn₂O₄, LiNiMnCoO₂ or lithiated nickel cobalt aluminum oxide LiNiCoAlO₂.

The invention that has just been described offers many advantages:
better control of the plastic deformations induced by compressing the end zones of the bundle, which makes it possible to obtain a dense layer in zones in order to perform reliable and effective welding of the current collector to each end zone of the bundle. Thus, for someone designing a battery or a supercapacitor, this allows optimization of the height of the end zones of the bundle usually between 1 and 5 mm. With the invention, the inventors think that we may envisage reducing this height by an amount of the order of 20 to 50%, depending on the formats and types of electrodes (thicker or thinner) used;
retaining the usual steps of production and assembly of the battery or supercapacitor, notably retaining the tooling for axial compacting of the ends of the electrochemical bundle.

### DETAILED DESCRIPTION

Other advantages and features of the invention will become clearer on reading the detailed description of embodiment examples of the invention, provided for purposes of illustration, and nonlimiting, referring to the following figures, where:

FIG. 1 is a schematic exploded perspective view showing the different elements of a lithium-ion battery,

FIG. 2 is a front view showing a lithium-ion battery with its flexible container according to the prior art,

FIG. 3 is a perspective view of a lithium-ion battery according to the prior art with its rigid container consisting of a case;

FIG. 4 is a reproduction of a photographic perspective view of an electrochemical bundle of a lithium-ion battery according to the prior art, the bundle consisting of a single electrochemical cell wound on itself by winding;

FIGS. 5A and 5B are side and top views respectively of a positive electrode of the electrochemical bundle according to FIG. 4;

FIGS. 6A and 6B are side and top views respectively of a negative electrode of the electrochemical bundle according to FIG. 4;

FIG. 7 is a photographic sectional view of a lateral end of a bundle according to the prior art on which the steps of axial compacting and of welding of a current collector have been carried out, FIG. 7 showing a first defect zone;

FIG. 7A is a photographic view of a detail of FIG. 7, showing a second defect zone;

FIG. 8 is a photographic sectional view of a lateral end of a bundle according to the prior art on which the steps of axial compacting and of welding of a current collector have been carried out, FIG. 8 showing a third defect zone;

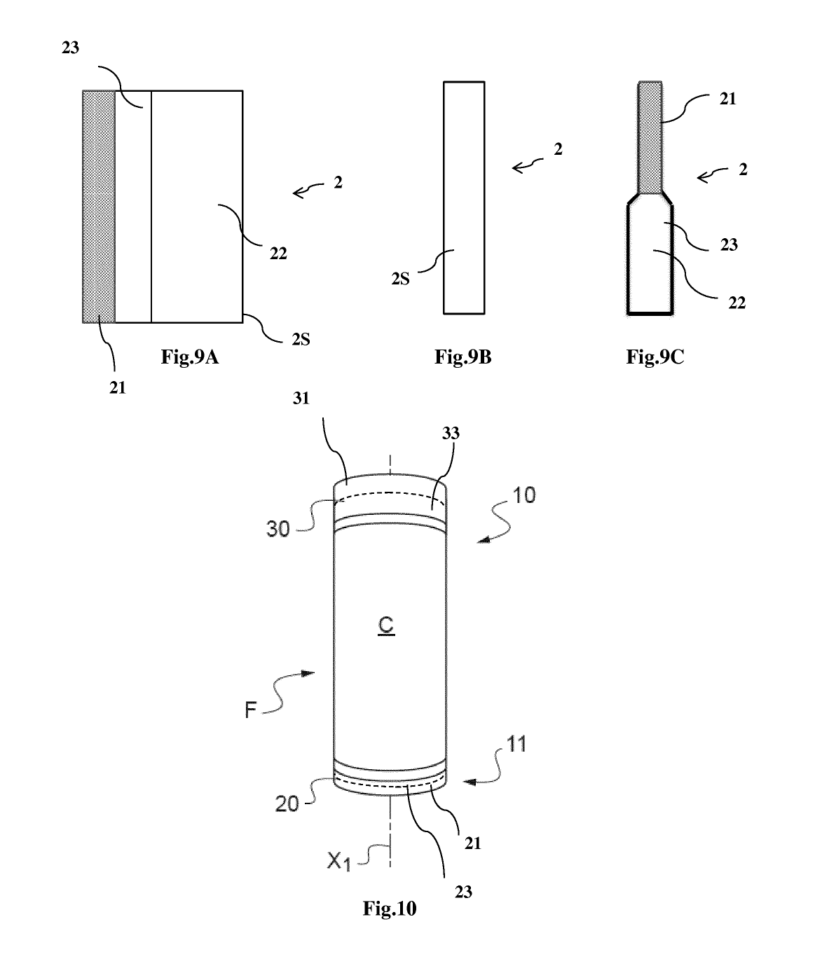

FIGS. 9A and 9B are side and top views respectively of a positive electrode strip according to the invention;

FIG. 9C shows a variant embodiment of a positive electrode strip according to the invention;

FIG. 10 is a reproduction of a photographic perspective view of an electrochemical bundle of a lithium-ion battery according to the invention, the bundle consisting of a single electrochemical cell wound on itself by winding;

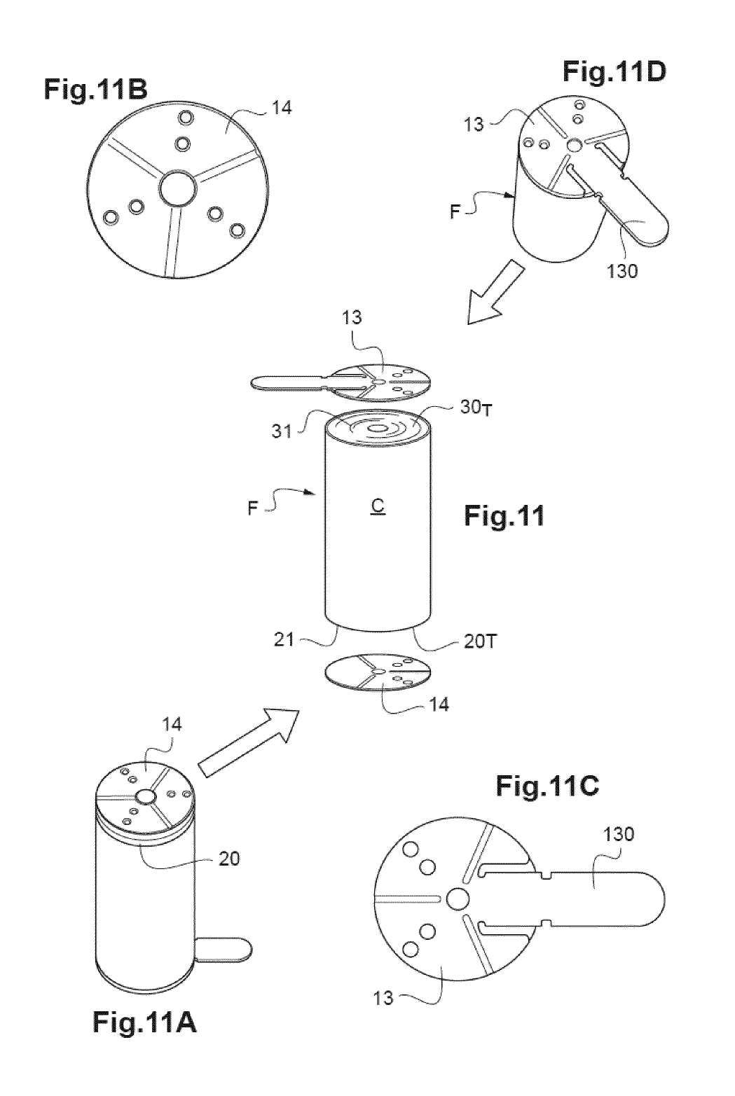

FIGS. 11 and 11A to 11D are reproductions of photographic views showing in perspective and in top view each of the two current collectors welded to one of the lateral ends of a bundle made according to the invention;

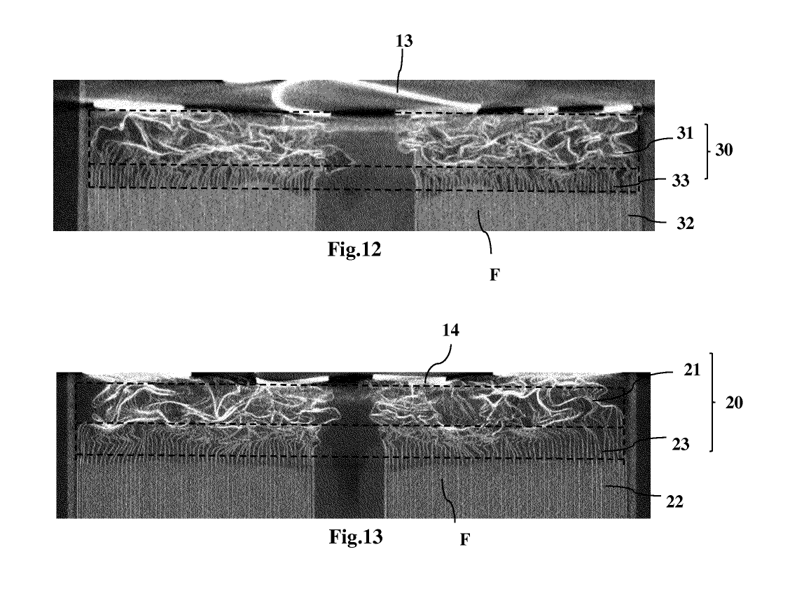

FIG. 12 is a photographic sectional view of a lateral end of a bundle according to the invention on which the steps of axial compacting and of welding a current collector have been carried out;

FIG. 13 is a photographic sectional view of the other lateral end of a bundle according to FIG. 12.

For clarity, the same references denoting the same elements of a lithium-ion battery according to the prior art and according to the invention are used for all FIGS. 1 to 13.

It should be noted that the various elements according to the invention are only shown for the sake of clarity and they are not to scale.

It should also be noted that the terms “length” and “lateral” referring to an electrode relate to when it is flat, before winding.

The terms “height” and “lateral” referring to the electrochemical bundle relate to the vertical configuration of its lateral ends respectively at the top and at the bottom.

FIGS. 1 to 8 have already been discussed in detail in the preamble. Therefore they are not described below.

To improve the electrical connection between an electrochemical bundle of a lithium-ion battery and its output terminals, the inventors propose a new design of electrode and a new method for producing the electrochemical bundle starting from this electrode.

The metal strips of square or rectangular section supporting the active insertion materials of electrodes may have a thickness between 5 and 50 μm. For an anode strip 3, it may advantageously be a strip of copper with a thickness of the order of 12 μm. For a cathode strip 2, it may advantageously be a strip of aluminum with a thickness of the order of 20 μm.

According to the invention, a positive electrode 2 or a negative electrode 3 comprises a lateral metal band with an end zone 21 or 31 for which the properties of its metallic strip material and/or its geometry is (are) modified relative to the rest of the strip, i.e. in an intermediate zone 23 or 33 of the edge 20 or 30 and in the central portion 22 or 32.

Thus, owing to this modified end zone 21 or 31, as described hereunder, in the operation of axial compacting of the bundle on one and/or other of its lateral ends, i.e. compacting applied on said end zone, there will be inelastic buckling localized on just the end zone.

The intermediate zone 23 or 33 provides security of mechanical protection during compacting as it will not deform.

Conversely, the central portion and if applicable an intermediate safety zone in the band devoid of active insertion material does not deform during compacting.

FIGS. 9A and 9B show an embodiment example of this end zone 21 on a metal strip 2S of cathode 2.

In this example, the strip has the same thickness over its whole area. However, the end zone 21 has undergone heat treatment, such as annealing, differentiated with respect to the intermediate zone 23 and the central portion 22 intended to be covered with the lithium insertion material. Typically, after treatment, the end zone 21 may have a breaking strength coefficient Rm lower than that of the rest of the surface (zone 23, central portion 22).

Also typically, after an annealing treatment, the end zone 21 may have a metallurgical state, slightly hardened, of type 0, H12, or H22 and H24 for aluminum, whereas the rest of the surface (zone 23, central portion 22) retains a work-hardened state, of type H14 to H18 for aluminum.

The same procedure is followed for producing an end zone 31 on a metal strip 3S of anode 3.

FIG. 9C shows a variant embodiment according to which the whole metal strip 2S has the same microstructure, and therefore has not undergone differentiated treatments. However, the end zone 21 is of smaller thickness than the rest of the surface (zone 23, central portion 22).

This variant according to FIG. 9C makes it possible, during axial compacting, to control the inelastic deformation of the end zone by limiting the disturbances of alignment observed up to now in the intermediate zones 23 or 33 of the bundles made according to the prior art. Reducing the thickness of the strip in the end zone 21, for example by a factor of 2, requires increasing its height, before deformation, by a factor of the order of 1.5 to 1.7 only taking into account this better control of the plastic deformations during the step of compression by axial compacting.

The various steps of this method of production according to the invention will now be described, referring to FIGS. 10 to 11.

Step a/:

The anode 3, the cathode 2 and at least one separator film 4 of the electrochemical cell C are wound by winding around a support (not shown).

The bundle is therefore of cylindrical shape elongated along a longitudinal axis X1, with, at one 10 of its lateral ends, a band 30 of uncoated anode 3 with an end zone 31 modified relative to the intermediate zone 33 and, at the other 11 of its lateral ends, a band 20 of uncoated cathode 2 with an end zone 31 modified relative to the intermediate zone 33.

Step b/:

Axial compacting is then carried out along the axis X1 of bands 20, 30 of the electrochemical bundle, on the entire surface of the lateral ends 10, 11.

The axial compacting consists of compression with a flat or structured tool with a bearing surface approximately equal to the surface of each of the lateral ends of the bands 20 or 30.

When the geometry required for the battery is cylindrical, the tool and the electrochemical bundle are arranged coaxially during the axial compacting.

Axial compacting is carried out once or more than once. It may consist of compression in one or more reciprocating relative movements, i.e. at least one movement to and fro along axis X1 of the bundle, until either a desired bundle dimension along X1, or a predetermined value of maximum compressive stress, is reached.

During application of this compressive stress, the end zones 21 and 31 undergo inelastic buckling and bend, whereas the intermediate zones 23 and 33 and the central portions 22 and 32 covered with the insertion materials do not deform.

A substantially flat base is thus obtained on the compacted portion of surface 20T, 30T, not bent down, of each lateral end.

Then, at one of the lateral ends 11 of the bundle, the base formed by the compacted portion 20T of the cathode (positive edges) is welded to a usual current collector 14 in the form of a full disk, itself intended to be welded afterwards to the base 8 of the battery case 6 (FIGS. 11, 11A, 11B).

In the same way, at the other lateral end 10 of the bundle, the base formed by the compacted portion 30T of the anode (negative edges) is welded to a portion of a usual current collector 13 in the form of a full disk pierced at its center and a tab 130 projecting laterally from the disk 13 (FIG. 11, 11C, 11D).

The definitive production of the battery is finalized in the usual way.

Thus, although not shown, the bundle with the collector 13 is introduced into a rigid aluminum container forming only the lateral envelope 7 of the case 6. In particular, during this step it is necessary to ensure that the tab 130 does not hamper introduction. For this purpose, the latter is advantageously folded upwards.

The collector 14 is welded to the base 8 of the case 6.

The collector 13 is welded to a negative pole 50 forming a lead-in of a cover 9 of case 6.

Then the cover 9 is welded to the rigid metal container 7.

This is followed by a step of filling the case 6 with an electrolyte, through a through-hole (not shown) made in the cover 9.

Production of the Li-ion battery according to the invention ends with sealing the filling hole.

Other variants and improvements may be made while remaining within the scope of the invention.

Finally, although the case 6 in the embodiments illustrated that have just been presented in detail is made of aluminum, it may also be made of steel, or of nickel-plated steel. In a variant of this kind, a case made of steel or of nickel-plated steel constitutes the negative pole, with the lead-in 9 then constituting the positive pole.

The invention is not limited to the examples that have just been described; notably, features of the examples illustrated may be combined in variants that are not illustrated.

### REFERENCE CITED

[1]: MÉTAUX & ALLIAGES, TECHNOLOGIE DES MËTAUX ET ALLIAGES PARTICULIÈREMENT en AÉRONAUTIQUE (METALS & ALLOYS, TECHNOLOGY OF METALS AND ALLOYS PARTICULARLY in AERONAUTICS), Dominic Ottello, pages 1-36, http://aviatechno.net/files/metauxalliages.pdf

1. An electrode for an electrochemical bundle of a metal-ion battery or of a supercapacitor, comprising a substrate formed of a metal strip comprising a central portion that supports an active metal-ion insertion material, and a lateral band, called edge, that lacks active insertion material, the lateral band comprising an end zone for which the properties of its metallic material and/or its geometry is (are) modified relative to the rest of the strip in the edge and in the central portion, so as to cause localized plastic buckling on the end zone when a predetermined compressive stress (E) is applied on said end zone, the central portion not deforming under the predetermined compressive stress.

2. The electrode as claimed in claim 1, wherein the lateral band comprises an intermediate zone, between the central portion and the end zone, for which the properties of its metallic material and/or its geometry are selected in such a way that said intermediate zone does not deform under the predetermined compressive stress.

3. The electrode as claimed in claim 2, wherein the intermediate zone comprises stiffeners distributed uniformly along its length.

4. The electrode as claimed in claim 1, wherein he Young's modulus and/or the elastic limit of the end zone is (are) modified by applying one or more thermomechanical treatments.

5. The electrode as claimed in claim 4, wherein the strip has a gradient of metallurgical state between the end zone and the intermediate zone.

6. The electrode as claimed in claim 1, wherein the thickness of the strip in the end zone is less than that of the strip in the edge and in the central portion.

7. The electrode as claimed in claim 1, wherein the strip is pierced with holes or slits or cavities uniformly distributed in the end zone.

8. The electrode as claimed in claim 1, wherein the strip is provided with at least one continuous groove along the length of the end zone.

9. The electrode as claimed in claim 1, wherein the width of the end zone, once the compressive stress is applied, is between 0.5 and 4 mm.

10. The electrode as claimed in claim 1, wherein the strip has a thickness between 5 and 20 μm in the end zone and a thickness between 10 and 20 μm in the central portion.

11. The electrode as claimed in claim 1, wherein the strip is made of aluminum or of copper.

12. A method for producing an electrochemical bundle (F) of a metal-ion battery (A) or of a supercapacitor, with a view to electrical connection thereof to the output terminals of the battery, comprising the following steps:
a/ supplying an electrochemical bundle (F) comprising at least one electrochemical cell (C) consisting of a cathode and an anode, on either side of a separator suitable for being impregnated with an electrolyte, the bundle having an elongated shape along a longitudinal axis X1, with at one of its lateral ends, the lateral band of the anode and at the other of its lateral ends, the lateral band of the cathode;
b/ axial compacting along axis X1 of at least one of the lateral bands of the electrochemical bundle; axial compacting being carried out once or twice so as to obtain, on at least one lateral end of the bundle, compacted end zone forming a substantially flat and continuous base, intended to be welded to a current collector.

13. A method for producing an electrochemical bundle (F) of a metal-ion battery (A) or of a supercapacitor, with a view to electrical connection thereof to the output terminals of the battery, comprising the following steps:
a′/ supplying an electrochemical bundle (F) comprising at least one electrochemical cell (C) consisting of a cathode and an anode on either side of a separator suitable for being impregnated with an electrolyte, the cathode and the anode each comprising a substrate, formed of a metal strip that supports, in its central portion, an active metal-ion insertion material, whereas its lateral band, called edge, lacks active insertion material and the properties of its metallic material and its geometry are identical to the rest of the strip in the edge and in the central portion, the bundle having an elongated shape along a longitudinal axis X1, with at one of its lateral ends, the lateral bands of the anode and at the other of its lateral ends, the lateral band or bands of the cathode;
b′/ axial compacting along axis X1 of at least one of the lateral bands of the electrochemical bundle with, beforehand or simultaneously, modification of the temperature of an end zone of said lateral band, the axial compacting being carried out once or twice so as to obtain, on at least one lateral end of the bundle, a compacted end zone forming a substantially flat, continuous base, intended to be welded to a current collector.

14. A method for producing an electrochemical bundle (F) of a metal-ion battery (A) or of a supercapacitor, with a view to electrical connection thereof to the output terminals of the battery, comprising the following steps:
a″/ supplying an electrochemical bundle (F) comprising at least one electrochemical cell (C) consisting of a cathode and an anode on either side of a separator suitable for being impregnated with an electrolyte, the cathode and the anode each comprising a substrate, formed of a metal strip that supports, in its central portion, an active metal-ion insertion material, whereas its lateral band, called edge, lacks active insertion material and the properties of its metallic material and its geometry are identical to the rest of the strip in the edge and in the central portion, the bundle having an elongated shape along a longitudinal axis X1, with at one of its lateral ends, the lateral bands of the anode and at the other of its lateral ends, the lateral band or bands of the cathode;
b″/ axial compacting along axis X1 of at least one of the lateral bands of the electrochemical bundle with, simultaneously, clamping radially on the axis X1 of an intermediate zone of said lateral band, leaving an end zone free radially, the axial compacting being carried out once or twice so as to obtain, on at least one lateral end of the bundle, a compacted end zone forming a substantially flat and continuous base, intended to be welded to a current collector.

15. The method for producing an electrochemical bundle as claimed in claim 12, the height of the end zone compacted on a lateral end being less than 4 mm, preferably between 0.5 and 2.5 mm.

16. The method for producing an electrochemical bundle as claimed in claim 12, the electrochemical bundle consisting of a single electrochemical cell (C) wound on itself by winding.

17. The method of production as claimed in claim 16, the gap between the anode strip and the cathode strip, considered in their central portion after winding, being between 100 and 500 μm.

18. A method for producing an electrical connection portion between an electrochemical bundle (F) of a metal-ion battery (A) and one of the output terminals of the battery, comprising the following steps:
making an electrochemical bundle (F) by the method as claimed in claim 12;
welding the base obtained to a current collector in the form of a plate, intended in its turn to be bonded or connected electrically to an output terminal of the battery.

19. A metal-ion storage battery or accumulator, comprising a case comprising:
a base to which one of the current collectors is welded to the electrochemical bundle; and
a cover with a lead-in forming an output terminal to which the other one of the current collectors is welded to the electrochemical bundle,
wherein said welding of the base and said welding of the cover are each welded according to the method as claimed in claim 18.

20. The metal-ion storage battery or accumulator as claimed in claim 19, in which:
the case is based on aluminum;
the negative electrode metal strip is made of copper;
the negative electrode active insertion material is selected from the group comprising graphite, lithium, titanate oxide Li₄TiO₅O₁₂; or based on silicon or based on lithium, or based on tin and alloys thereof;
the positive electrode metal strip is made of aluminum;
the positive electrode active insertion material is selected from the group comprising lithiated iron phosphate LiFePO4, lithiated cobalt oxide LiCoO2, lithiated manganese oxide, optionally substituted, LiMn2O4 or a material based on LiNixMnyCozO2 with x+y+z=1, LiNi0.33Mn0.33Co0.33O2, or a material based on LiNixCoyAlzO2 with x+y+z=1, LiMn2O4, LiNiMnCoO2 or lithiated nickel cobalt aluminum oxide LiNiCoAlO2.
